(19) United States
(12) Patent Application Publication
(10) Pub. No.: US 2016/0152517 A1
(43) Pub. Date: Jun. 2, 2016

(54) METHOD OF EDGE COATING MULTIPLE ARTICLES

(71) Applicant: CORNING INCORPORATED, Corning, NY (US)

(72) Inventors: Yu-Chin Chen, Taipei City (TW); Liang-Chien Cheng, Taichung City (TW); Tien-San Chi, Taichung City (TW); Chao-Yin Chuang, Taichung City (TW); Matthew John Towner, Campbell, NY (US); Kevin William Uhlig, Horseheads, NY (US); Thomas Achille Yorio, Painted Post, NY (US)

(21) Appl. No.: 14/953,701

(22) Filed: Nov. 30, 2015

Related U.S. Application Data
(60) Provisional application No. 62/086,284, filed on Dec. 2, 2014.

(51) Int. Cl. C03C 17/00; C03C 23/00; C03C 17/32

(52) U.S. Cl. CPC C03C 17/001; C03C 17/007; C03C 17/32; C03C 23/007; C03C 23/002; C03C 2217/78; C03C 2217/445; C03C 2217/478; C03C 2218/118; C03C 2218/30

(57) ABSTRACT

A method of edge coating includes preparing a stack including a plurality of articles interleaved with spacer pads. A layer of coating material is formed on a surface of a coating roller. A perimeter of the stack is positioned at a select coating gap relative to the surface of the coating roller, and the coating material is transferred from the surface of the coating roller to perimeter edges of the articles in the stack.

### CROSS-REFERENCE TO RELATED APPLICATIONS

This application claims the benefit of priority under 35 U.S.C. §119 of U.S. Provisional Application Ser. No. 62/086,284 filed on Dec. 2, 2014 the content of which is relied upon and incorporated herein by reference in its entirety.

### FIELD

The field relates to methods for strengthening and protecting glass articles that have been subjected to weakening processes such as separation and machining. More particularly, the field relates to a process for strengthening glass edges by applying protective coatings to the glass edges.

### BACKGROUND

In brittle materials, such as glass, fracture takes place initially at a flaw or microscopic crack in the material and then rapidly spreads across the material. The flexural strength of the material is a function of the largest critical flaw under tensile stress. The relationship between failure stress and crack size was developed by English engineer Alan Arnold Griffith and is expressed as follows:

$$σ = \frac{1}{Y} \frac{{K}_{1 C}}{\sqrt{c}} \qquad ( 1 )$$

where σ is failure stress, Y is a constant depending on the crack and sample geometry, K_{1C} is critical stress intensity factor or fracture toughness, and c is crack size in glass. According to equation (1), the failure stress, i.e., the applied stress required for failure, increases as the crack size reduces or as the critical stress intensity factor decreases.

Glass is known to be extremely strong in the freshly formed state. However, processes applied to the glass after forming, such as separation and machining, can induce flaws, e.g., chips and cracks, of various shapes, sizes, and dimensions in the edges of the glass. These flaws make the glass susceptible to damage since the flaws become failure sites at which fracture can be initiated when the glass is under high stress or when direct impact is made with the flaws. To improve resistance of the glass to impact damage, a protective coating may be applied to the flawed edges. The protective coating will cover the flaws, thereby preventing direct impact with the flaws.

### SUMMARY

Edge coating has been proven to protect the glass edge from impact, collision, and abrasion using accepted mechanical tests. The protection is mainly controlled by the coating thickness on top of the glass edge. The present disclosure discloses a method of edge coating several parts per process cycle in order to increase throughput without sacrificing coating performance.

In a first aspect, the method involves preparing a stack composed of a plurality of articles interleaved with spacer pads, forming a layer of coating material on a surface of a coating roller, positioning a perimeter of the stack at a select coating gap relative to the surface of the coating roller, and transferring the coating material from the surface of the coating roller to perimeter edges of the articles in the stack.

In a second aspect, the method is as described in the first aspect, and the stack is prepared such that the spacer pads are recessed within the stack.

In a third aspect, the method is as described in the second aspect, and a viscosity of the coating material and a thickness of each spacer pad are selected such that an overflow length of the coating material into a space between adjacent articles in the stack is less than 220 microns while transferring the coating material.

In a fourth aspect, the method is as described in any one of the first to the third aspects, and transferring of the coating material includes relative rotation between the stack and the coating roller.

In a fifth aspect, the method is as described in the fourth aspect, and the method further includes characterizing an edge profile of the stack prior to transferring the coating material.

In a sixth aspect, the method is as described in the fifth aspect, and characterization of the edge profile of the stack includes tracing the perimeter edge of each article in the stack using a displacement sensor.

In a seventh aspect, the method is as described in the fourth aspect, and forming of the layer of coating material includes dipping the coating roller in a pool of the coating material as the coating roller is rotated.

In an eighth aspect, the method is as described in any one of the first to the seventh aspects, and forming of the layer of coating material includes controlling the thickness of the coating material on the surface of the coating roller.

In a ninth aspect, the method is as described in any one of the first to the eighth aspects, and the method further includes maintaining the select coating gap between the perimeter of the stack and the surface of the coating roller while transferring the coating material.

In a tenth aspect, the method is as described in any one of the first to the ninth aspects, the coating material is a curable coating material, and the method further includes curing the coating material transferred to the perimeter edges of the articles.

In an eleventh aspect, the method is as described in any one of the first to the tenth aspects, the stack comprises more than two articles, and the perimeter edges of at least two of the articles in the stack simultaneously receive the coating material from the surface of the coating roller.

In a twelfth aspect, the method is as described in any one of the first to the tenth aspects, and the perimeter edges of all the articles in the stack simultaneously receive the coating material from the surface of the coating roller.

In a thirteenth aspect, the method is as described in any one of the first to the twelfth aspects, and preparing the stack includes aligning the perimeter edges of the articles at the perimeter of the stack.

In a fourteenth aspect, the method is as described in any one of the first to the thirteenth aspects, and the curable coating material comprises a hard coating material.

In a fifteenth aspect, the method is as described in any one of the first to the fourteenth aspects, and the curable coating material comprises silica particles.

It is to be understood that both the foregoing general description and the following detailed description are exemplary and are intended to provide an overview or framework for understanding the nature and character of the invention as it is claimed. The accompanying drawings are included to provide a further understanding of the invention and are incorporated in and constitute a part of this specification. The drawings illustrate various embodiments of the invention and together with the description serve to explain the principles and operation of the invention.

### BRIEF DESCRIPTION OF THE DRAWINGS

The following is a description of the figures in the accompanying drawings. The figures are not necessarily to scale, and certain features and certain views of the figures may be shown exaggerated in scale or in schematic in the interest of clarity and conciseness.

FIG. 1 shows a stack including articles interleaved with spacer pads.

FIG. 1A shows a top view of an alignment fixture that may be used in forming the stack of FIG. 1.

FIG. 2 shows the stack of FIG. 1 coupled to a motion device.

FIG. 3 shows characterization of an edge profile of the stack of FIG. 1.

FIG. 4A shows coating of the stack of FIG. 1 with a roller coater.

FIG. 4B is a front view of the stack and roller coater.

FIG. 5 shows curing of coating material on a coated stack.

FIG. 6A shows capillary effect in coating of a stack with thin spacer pads.

FIG. 6B shows absence of capillary effect on coating of a stack with thick spacer pads.

FIG. 6C is a chart showing coating material overflow length as a function of spacer pad thickness.

FIG. 7A shows process capability index for single-part coating.

FIG. 7B shows process capability index for multi-part coating.

### DETAILED DESCRIPTION

In one illustrative embodiment, a method of coating the perimeter edges of articles includes forming a stack of the articles interleaved with spacer pads. Each article may be made of a brittle material. In particular embodiments, each article is made of glass or glass-ceramic. Each article has a perimeter edge, where the term “perimeter edge” is intended to refer to the edge surface along the perimeter of the article. The perimeter edges of the articles may have flaws, for example, due to processes such as separation and machining. In general, the stack will have at least two articles and at least one spacer pad. The more articles there are in the stack, the less the average unit production time, also known as Takt time. In some examples, the stack may have more than ten articles.

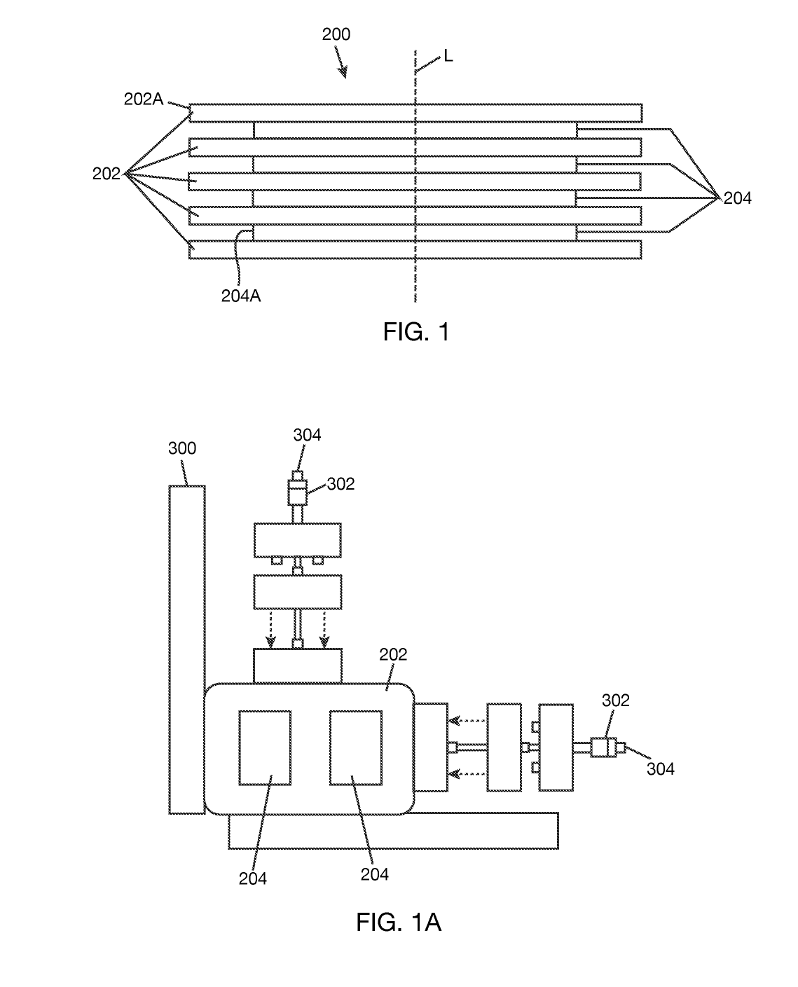

FIG. 1 shows an example stack 200 having articles 202 interleaved with spacer pads 204. The articles 202 are arranged in the stack 200 such that the perimeter edges 202A of the articles 202 are aligned at the perimeter of the stack 200. The articles 202 and spacer pads 204 are arranged in alternating layers in the stack 200 so that there is no physical contact between any two adjacent articles 202. In one embodiment, the articles 202 and spacer pads 204 are held together in the stack 200 by surface tension. In other embodiments, other measures may be taken to further secure the stack 200, such as clamping.

One or more spacer pads 204 may be used between any two adjacent articles 202. The spacer pads 204 may be made of conformable material so that the shape of the spacer pad 204 conforms to that of the adjacent articles 202. The spacer pads 204 are preferably made of materials that would not scratch or mar the surfaces of the articles 202. For example, the spacer pads 202 could be made of a polymeric material, such as butyl rubber, silicone, polyurethane, or natural rubber. The spacer pads 202 may be made of other materials besides a polymer material, such as a magnetic adhesive material, static adhesive material, and the like.

In one embodiment, the spacer pads 204 are selected to be smaller in width than the articles 202, which allows the spacer pads 204 to be arranged relative to the articles 202 such that the perimeter edges 204A of the spacer pads 204 are recessed within the stack 200. This would prevent the spacer pads 204 from interfering with the coating of the perimeter edges 202A of the articles 202. The width of the spacer pad 204 is taken to be the largest dimension of the spacer pad 202 in a direction transverse to the axial axis L of the stack 200. The thickness of the spacer pads 204 between the articles 202 may be selected to achieve a desired coating performance. The thickness of the spacer pads 204 determines the spacing between adjacent articles 202 along the axial axis L of the stack 200.

In one embodiment, the stack 200 is formed with the aid of an alignment fixture. With reference to FIG. 1A, the alignment stacking may include placing a first article 202 in a gage of an alignment fixture 300 and adjusting knobs 302 and ratchet stoppers 304 of the alignment fixture 300 to the proper stacking dimension. Spacer pads 204 are placed on the surface of the article 202 and another article 202 is placed on the spacer pads 204. This placement of spacer pads 204 and article 202 is repeated until the stack 200 has the desired number of articles 202. Finally, the ratchet stopper 304 is loosened to release the stack 200. This alignment procedure will create a stack 200 where the perimeter edges of the articles 202 are aligned (or flush) at the perimeter of the stack 200 so that the perimeter edges can be processed simultaneously. Other suitable methods for stacking the articles may be used.

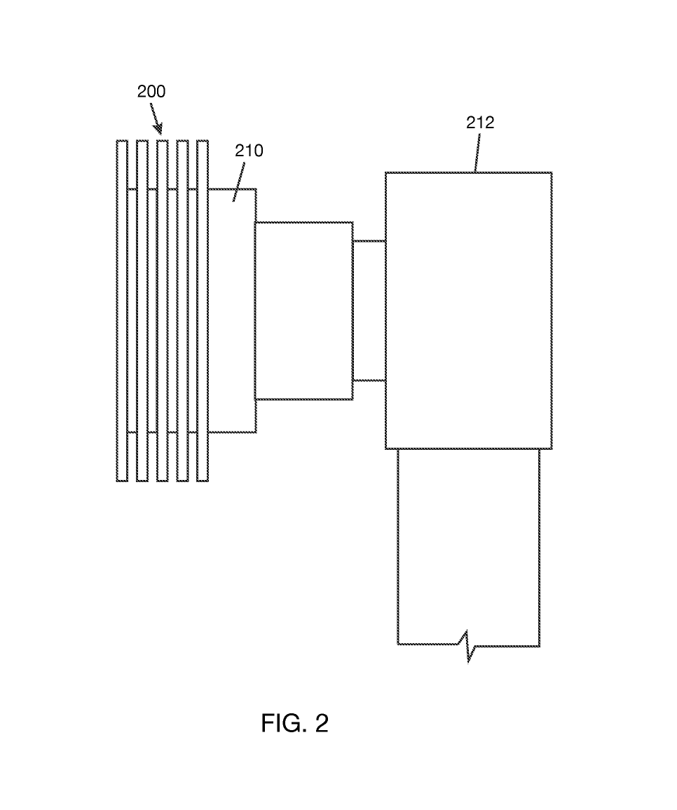

In one embodiment, the method may include coupling the stack 200 to a motion device, where the motion device may support the stack 200 and provide any desired motions to the stack 200 during the remaining steps of the method. For example, FIG. 2 shows the stack 200 held by a vacuum chuck 210, which is coupled to a motion device 212 that is capable of providing at least one of vertical, horizontal, and rotational motion. Other means of coupling the stack 200 to a motion device besides vacuum may be used.

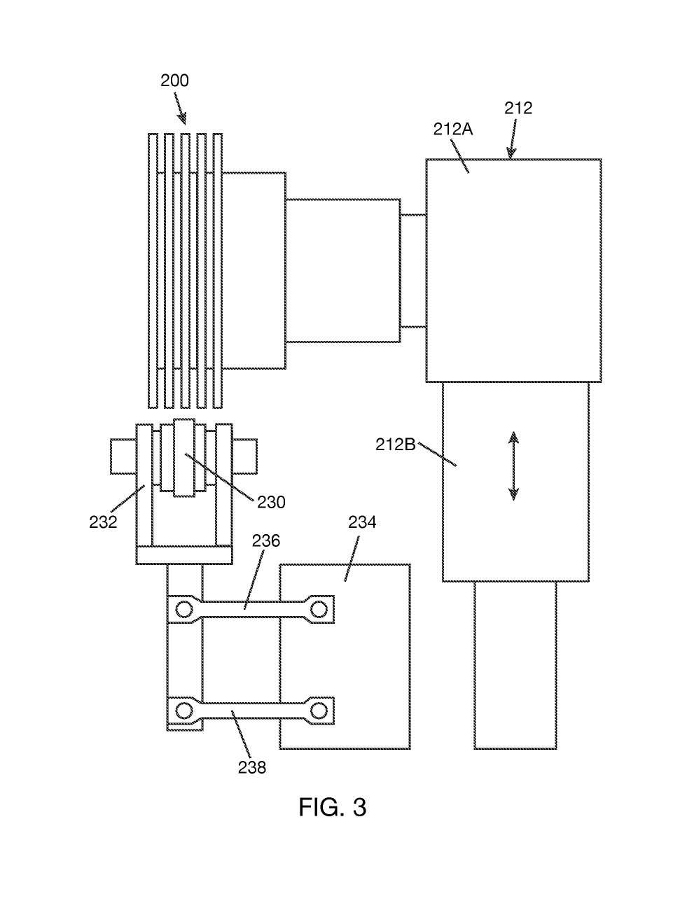

In one embodiment, the method may include characterizing (or measuring) the edge profile of the stack 200. Various methods may be used for this characterization. In one embodiment, the edge profile is characterized using a linear variable displacement transformer (LVDT) sensor. FIG. 3 shows an example of a measurement setup with a LVDT sensor 230 mounted on a support 232, which is coupled to a mounting block 234 by pivotable linkages 236, 238. A spring mechanism (not visible in the drawing) normally biases the pivotable linkages 236, 238 upwardly. Opposite to the LVDT mechanism is the motion device 212 holding the stack 200. To characterize the edge profile of the stack 200, the stack 200 is brought into contact with the LVDT sensor 230 and rotated relative to the LVDT sensor 230. A rotary actuator part 212A of the motion device 212 provides the rotary motion to the stack 200. As the stack 200 is rotated, the LVDT sensor 230 traces the perimeter of the stack 200. Contact is maintained between the stack 200 and the LVDT sensor 230 during rotation of the stack 200 by means of the spring mechanism that biases the pivotable linkages 236, 238 upwardly and by vertical motion of the stack 200. The rotary actuator 212A is mounted on a vertical support 212B, which can move up and down as the stack 200 rotates relative to the LVDT sensor 230, thereby enabling vertical motion of the stack 200. The LVDT sensor 230 includes a ferromagnetic core disposed within a series of inductors and produces electrical output proportional to the physical position of the ferromagnetic core within the series of inductors. The characterization of the edge profile of the stack 200 may involve measuring the edge profile of a selected one of the articles in the stack 200 or all of the articles in the stack 200. Also, other methods may be used to characterize the edge profile of the stack 200, such as non-contact, optical-based methods.

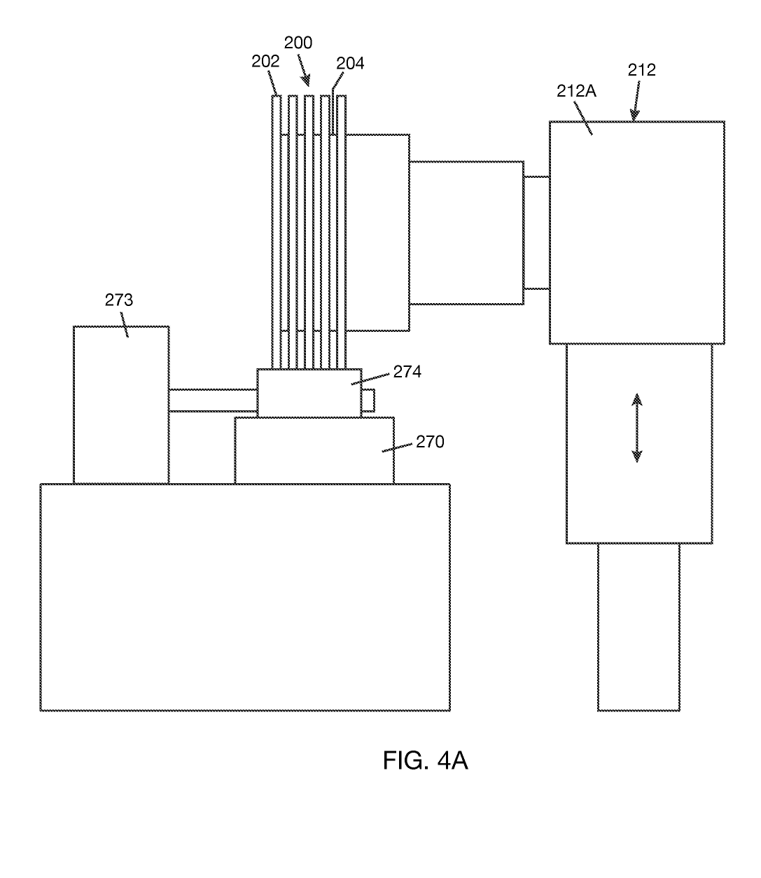

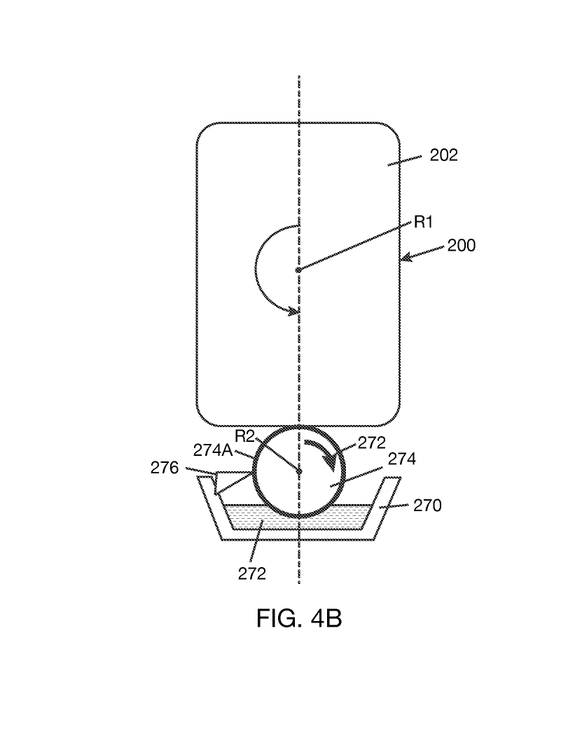

The method includes applying a protective coating to the perimeter edges of the articles 202 in the stack 200. FIGS. 4A and 4B show an example of a coating setup with a vessel 270 containing a coating material 272 and a rotating coating roller 274. A motor 273 provides the desired rotation to the coating roller 274. The coating material 272 is picked up by the coating roller 274 and is metered by a doctor blade/opening 276 (i.e., the layer thickness of the coating material 272 on the surface 274A of the coating roller 274 is controlled by the doctor blade/opening 276). To apply the coating to the perimeter edges of the articles 202 in the stack 200, the perimeter of the stack 200 is positioned adjacent to the surface 274A of the coating roller 274. In one embodiment, the gap between the perimeter of the stack 200 and the surface of the coating roller 274 during the coating process, herein referred as the “coating gap,” may be the same or less than the thickness of the coating material 272 on the surface of the coating roller 272. In one embodiment, a rotational axis R1 of the stack 200 is aligned with, and parallel to, a rotational axis R2 of the coating roller 274. The perimeter edges of the articles 202 in the stack 200 are coated with the coating material 272 as the stack 200 and coating roller 274 rotate relative to each other. To maintain the desired coating gap between the coating roller 274 and stack 200, the stack 200 may be moved vertically (or in a direction transverse to the rotational axes R1, R2) according to the measured edge profile data of the stack 200. A portion or the entire length of each perimeter edge of the articles in the stack 200 may be coated with the coating material 272. The length of the coating roller 274 (measured along the rotational axis R2) may be slightly greater than that of the stack 200 so that all the perimeter edges of all the articles in the stack 200 can be coated simultaneously. Alternatively, if the coating roller 274 is shorter than the stack 200, then the stack 200 can be coated in sections. In general, perimeter edges of multiple articles will be coated for each pass of the coating roller 274.

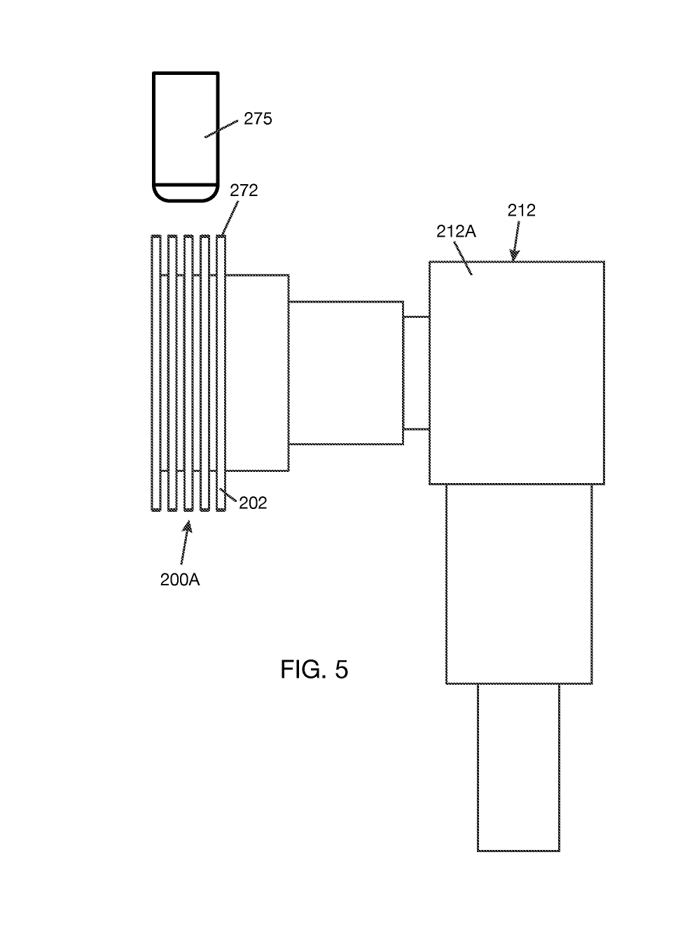

In one example, the coating material 272 is a curable coating material. In this case, as shown in FIG. 5, the method may include curing the coating material 272 applied to the perimeter of the coated stack 200A using, for example, an ultraviolet radiation source 275 or a thermal source. In order to avoid impact damage, hard (impact-resistant) coating materials are typically preferred for edge protection. Examples of hard coating materials include, but are not limited to, acrylic, epoxy, and transparent polyimide. Soft coating materials such as silicone may also be used for edge protection. In one embodiment, silica particles may be added to the coating material to adjust the coefficient of thermal expansion (CTE) ratio of the coating material to the article, e.g., if the article is made of glass.

After curing the coating material 200, the coated stack 200A may be returned to the measurement setup of FIG. 3, or a different measurement setup, for characterization of the coated edge profile. The resulting measurement data may be used to determine whether the edge coating is uniform and to determine what adjustments to the coating parameters are needed. After any additional measurements, the coated stack can be disassembled, and further finishing processes may be applied to the edge-coated articles.

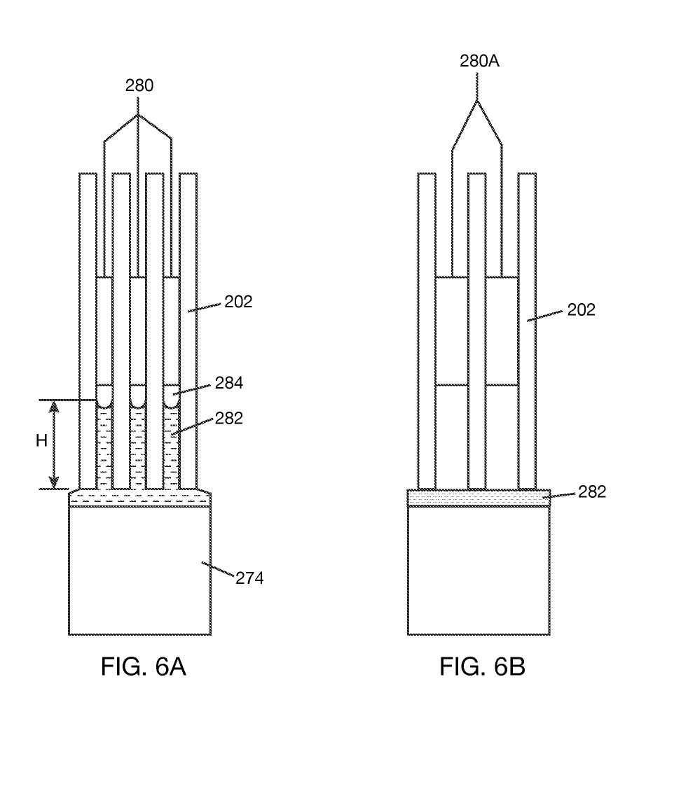

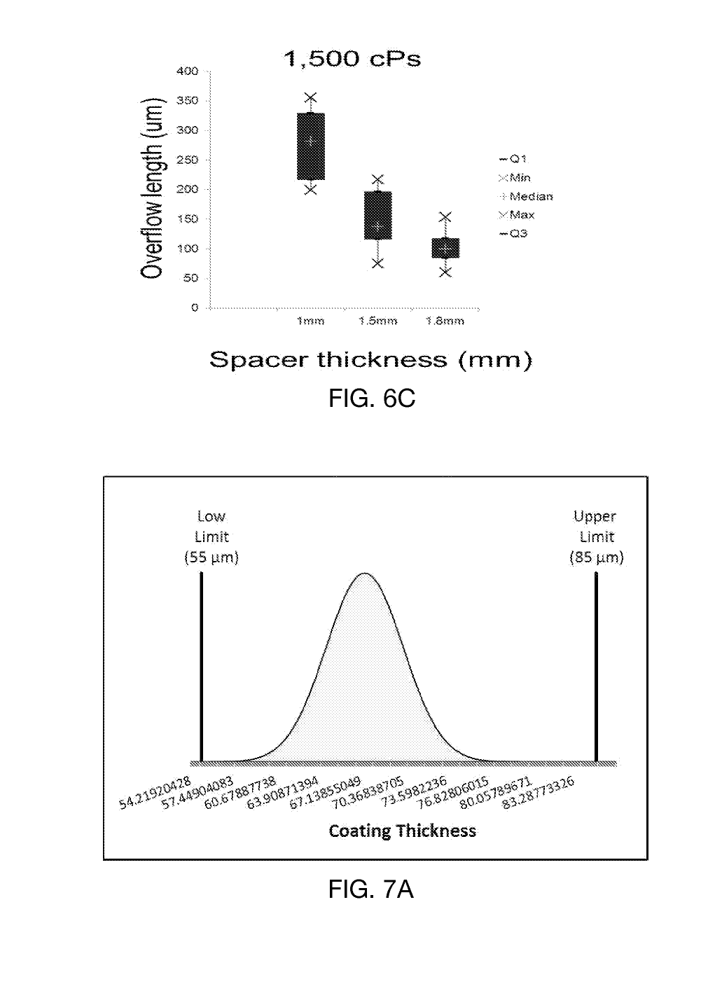

The thickness of the spacer pads (204 in FIG. 1) included in the stack 200 should be selected by considering coating material viscosity and capillary effect. FIG. 6A illustrates the capillary effect that occurs with spacer pads 280 that are too thin, i.e., the coating material 282 is shown rising into the narrow spaces 284 created by the thin spacer pads 280 between the articles 202. Such capillary effect can result in coating material overflow to the non-edge surfaces of the articles, resulting in uneven or undesirable coating of the non-edge surfaces. For comparison, FIG. 6B shows absence of the capillary effect with thicker spacer pads 280A between the articles 202.

For illustration purposes, FIG. 6C shows overflow length of a coating material as a function of spacer thickness for a 1,500 cps coating material. Overflow length is coating material flow to glass surface (or the height of the column of coating material in the space between adjacent articles; see H in FIG. 6A). When the spacer pad is only 1.0 mm thick, the overflow length is above 250 microns. FIG. 6C shows that increasing spacer pad thickness will reduce overflow length.

In general, thicker spacer pads will have relatively low capillary effect. From a mass production point of view, thinner spacer pads will allow more articles to be stacked in one run. It is desirable to minimize capillary effect while maximizing process Takt time. In one embodiment, a coating overflow length less than 220 microns provides a good compromise between capillary effect and Takt time.

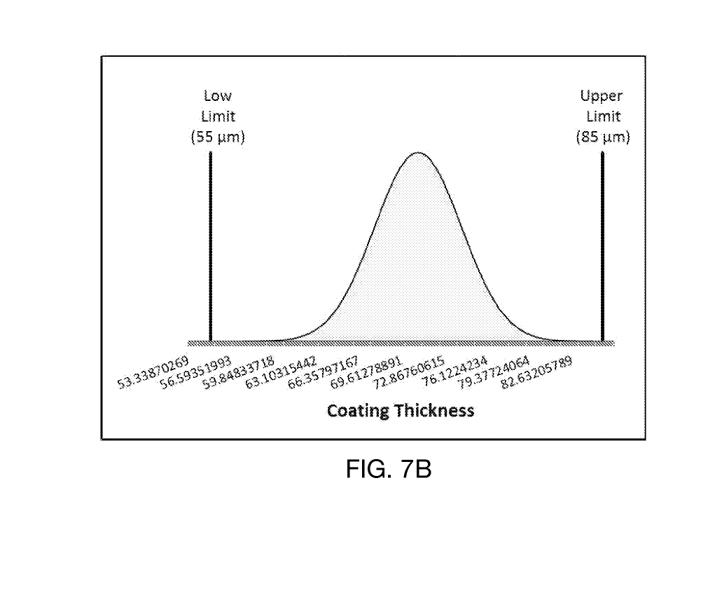

FIG. 7A shows the process capability index for single-part coating. In the single-part coating process, a stack of articles is not made and only one article is coated per process cycle. FIG. 7B shows the process capability index for multi-part coating using the method described above. In the multi-part coating, a stack of articles is made and several articles are coated per process cycle. As can be observed from the graphs of FIGS. 7A and 7B, the multi-part coating performance is comparable to that of the single-part coating performance. The multi-part coating has a process capability index of 1.4165, while the single part coating has a process capability index of 1.4111. The process capability index for the multi-part coating indicates that the defect opportunity per million is about 3,000 pieces, which is similar to the defect opportunity for the single part coating. Therefore, process Takt time can be substantially reduced with the multi-part coating without losing any substantial coating performance compared to the single-part coating.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

1. A method of edge coating, comprising:
preparing a stack including a plurality of articles interleaved with spacer pads;
forming a layer of coating material on a surface of a coating roller;
positioning a perimeter of the stack at a select coating gap relative to the surface of the coating roller; and
transferring the coating material from the surface of the coating roller to perimeter edges of the articles in the stack.

2. The method of claim 1, wherein the stack is prepared such that the spacer pads are recessed within the stack.

3. The method of claim 2, wherein a viscosity of the coating material and a thickness of each spacer pad are selected such that an overflow length of the coating material into a space between adjacent articles in the stack is less than 220 microns while transferring the coating material.

4. The method of claim 1, wherein transferring the coating material comprises relative rotation between the stack and the coating roller.

5. The method of claim 4, further comprising characterizing an edge profile of the stack prior to transferring the coating material.

6. The method of claim 5, wherein characterizing the edge profile of the stack comprises tracing the perimeter edge of each article in the stack using a displacement sensor.

7. The method of claim 4, wherein forming the layer of coating material comprises dipping the coating roller in a pool of the coating material as the coating roller is rotated.

8. The method of claim 7, wherein forming the layer of coating material further comprises controlling the thickness of the coating material on the surface of the coating roller.

9. The method of claim 4, further comprising maintaining the select coating gap between the perimeter of the stack and the surface of the coating roller while transferring the coating material.

10. The method of claim 1, wherein the coating material is a curable coating material, and further comprising curing the coating material transferred to the perimeter edges of the articles.

11. The method of claim 1, wherein the stack comprises more than two articles, and wherein the perimeter edges of at least two of the articles in the stack simultaneously receive the coating material from the surface of the coating roller.

12. The method of claim 1, wherein the perimeter edges of all the articles in the stack simultaneously receive the coating material from the surface of the coating roller.

13. The method of claim 1, wherein preparing the stack comprises aligning the perimeter edges of the articles at the perimeter of the stack.

14. The method of claim 1, wherein the curable coating material comprises a hard coating material.

15. The method of claim 1, wherein the curable coating material comprises silica particles.
